(19) United States
(12) Patent Application Publication
(10) Pub. No.: US 2010/0271738 A1
(43) Pub. Date: Oct. 28, 2010

(54) CIRCUIT FOR ELECTRIC OVER STRESS IMMUNITY

(75) Inventor: KUO-CHEN TSAI, Hsinchu (TW)

Correspondence Address: Tung & Associates;Suite 120, 838 W. Long Lake Road, Bloomfield Hills, MI, 48302, US

(73) Assignee: Richtek Technology Corporation, R.O.C.

(21) Appl. No.: 12/427,812

(22) Filed: Apr. 22, 2009

(51) Int. Cl. H02H 9/04

(52) U.S. Cl. 361/56

(57) ABSTRACT

The present invention discloses a circuit for electric over stress immunity comprising: a resistor receiving an external voltage; a zener diode having a cathode electrically connected with the resistor; and a functional circuit to be protected, which is electrically connected with both sides of the zener diode; wherein the resistor, the zener diode and the functional circuit are integrated in an integrated circuit.

### FIELD OF INVENTION

The present invention relates to a circuit for electric over stress (EOS) immunity to prevent EOS from damaging a functional circuit.

### DESCRIPTION OF RELATED ART

Among various applications of electronic devices, including but not limited to TFT LCD panel, EOS is an issue which requires immunity protection because it is often higher than 5V, the maximum rating of a PMOS and NMOS transistor, and causes damages to the power management chip.

FIG. 1 shows a prior art circuit for solving this problem, wherein a resistor Rex, a capacitor Cex, and a zener diode Zex are provided for the power management chip 10 externally. The RC circuit formed by the resistor Rex and the capacitor Cex filters the EOS in an alternating current (AC) input and the zener diode Zex clamps the level of a DC input voltage Vin converted from the AC input. The drawbacks of this prior art include: (1) discrete devices outside of the chip increase the cost of the overall circuit; (2) the zener diode will be damaged if the EOS is too high, and the power management chip 10 may still be damaged by the direct current EOS.

There are other prior art proposals to prevent from ESD (electro-static damage) and EOS, such as by an SCR (silicon-controlled rectifier) or by a circuit with gate-coupling as shown in FIG. 2. These proposals might be effective to prevent from ESD and AC EOS, but they can not protect the circuit from the DC EOS problem.

### SUMMARY OF THE INVENTION

In view of the foregoing problems of the prior art, an objective of the present invention is to provide a circuit for EOS immunity to prevent the EOS from damaging the circuit.

According to one perspective of the present invention, a circuit for EOS immunity comprises: a resistor receiving an external voltage; a zener diode having a cathode electrically connected with the resistor; and a functional circuit to be protected, which is electrically connected with both sides of the zener diode; wherein the resistor, the zener diode and the functional circuit are integrated in an integrated circuit.

In the foregoing circuit, the functional circuit for example can be a power management circuit.

In the foregoing circuit, a breakdown voltage of the zener diode is preferably lower than that of the functional circuit.

In the foregoing circuit, the resistor has a resistance Rin which preferably meets the relationship below:

(Vin−V_{ZBD})/I_{ZBD}_{_{—}}_{max<}Rin<(Vin−V_{MIN})/I_{OP}

wherein, V_{MIN} is a minimum operation voltage of the functional circuit; I_{OP} is an operation current of the functional circuit; V_{ZBD} is a breakdown voltage of the zener diode; and I_{ZBD}_{_{—}}ₘₐₓ is a maximum breakdown current of the zener diode.

The objectives, technical details, features, and effects of the present invention will be better understood with regard to the detailed description of the embodiments below, with reference to the drawings.

### BRIEF DESCRIPTION OF THE DRAWINGS

FIG. 1 shows a prior art circuit for EOS immunity.

FIG. 2 shows another prior art for EOS immunity.

FIG. 3 shows an embodiment of the present invention.

FIG. 4 shows the advantages of the present invention over the prior art.

FIGS. 5A-5E illustrate that the resistor Rin can be embodied in various forms.

### DESCRIPTION OF THE PREFERRED EMBODIMENTS

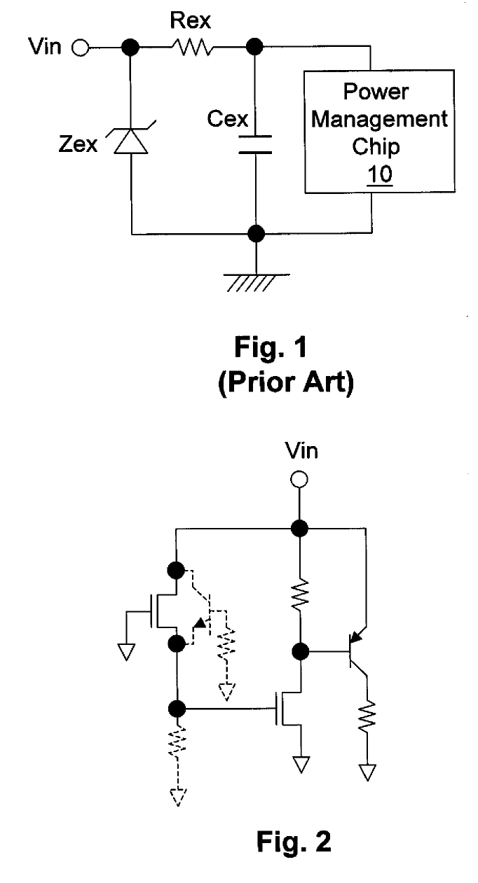

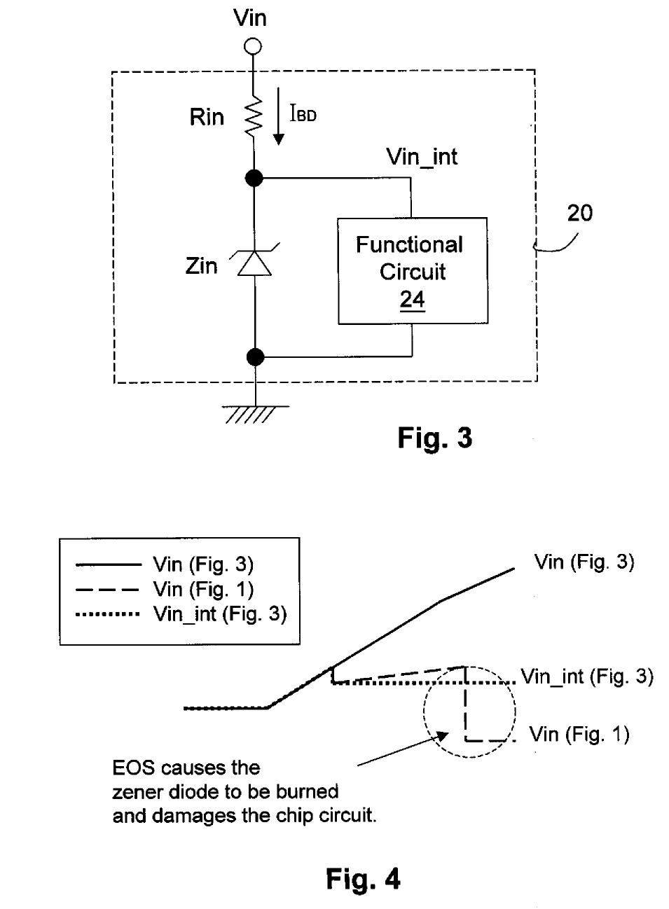

FIG. 3 is a schematic circuit diagram showing an embodiment of the present invention. As shown in the figure, the present invention provides a resistor Rin and a zener diode Zin which are built in an integrated circuit 20. A functional circuit 24 is to be protected against EOS damage, which can be any circuit such as but not limited to the power management chip 10 in FIG. 1. The capacitor Cex of the prior art is not required either inside or outside of the integrated circuit.

When the EOS is higher than a threshold value such that the zener diode Zin breaks down, the breakdown current I_{BD} is limited by the resistor Rin and the majority of the current is discharged to ground via a reverse path of the zener diode Zin. Further, an internal voltage Vin_int is clamped within the breakdown voltage of the zener diode Zin; hence, the internal functional circuit 24 is not damaged.

As shown in FIG. 4, when the input voltage Vin increases and the EOS becomes stronger, in the prior art shown in FIG. 1, the power management chip 10 and the zener diode Zex are both damaged after the zener diode Zex breaks down. Yet, the present invention as shown in FIG. 3 has a resistor Rin which limits the breakdown current I_{BD}, such that the internal functional circuit 24 and the zener diode Zin are both protected from EOS damages.

To achieve the above-mentioned effect, the breakdown voltage of the zener diode Zin should be lower than the breakdown voltage of the internal functional circuit 24 in the circuit shown in FIG. 4. Additionally, given that the lowest operation voltage of the internal functional circuit 24 is V_{MIN}, that the operation current of the internal functional circuit is I_{OP}, that the breakdown voltage of the zener diode Zin is V_{ZBD}, and that the maximum breakdown current of the zener diode Zin is I_{ZBD}_{_{—}}ₘₐₓ, the resistor Rin should preferably meet the relationship below:

(Vin−V_{ZBD})/I_{ZBD}_{_{—}}_{max<}Rin<(Vin−V_{MIN})/I_{OP}

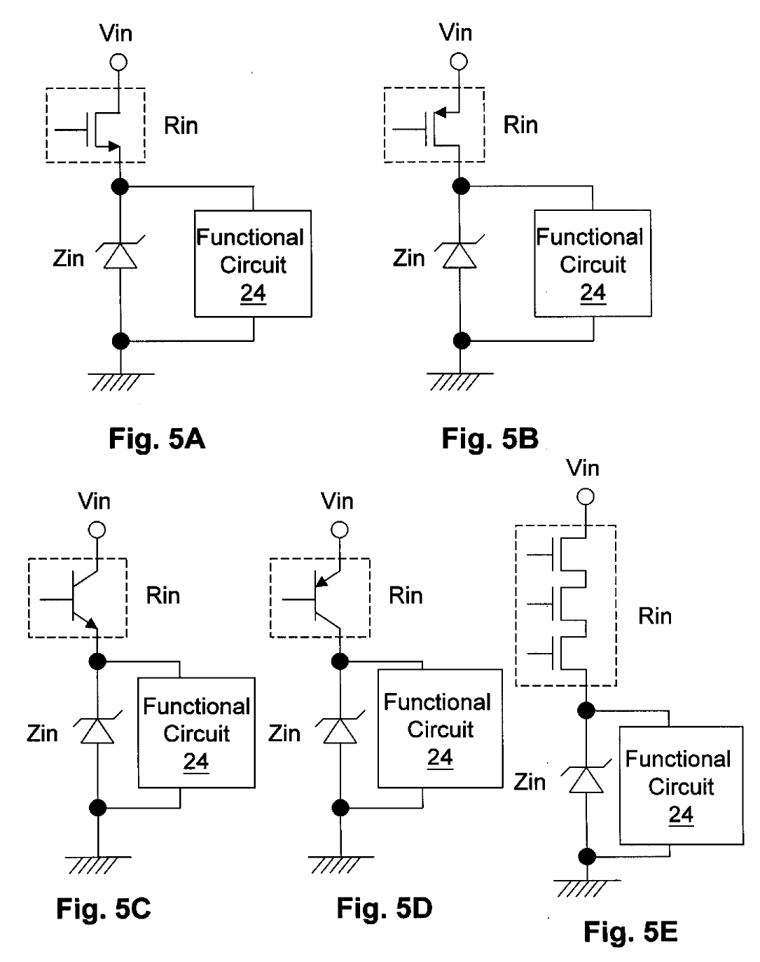

The resistor built in the integrated circuit 20 can be formed by any device(s) with a suitable resistance. The resistor can be made of an active device(s), a passive device(s), or a combination of the above, such as a polysilicon line, an NMOS transistor, a PMOS transistor, a PNP BJT (Bipolar Junction Transistor), an NPN BJT, two or more of the above devices connected in series or in parallel, etc. FIGS. 5A-5E illustrate, by way of example, various forms of the resistor Rin. Those skilled in this art can readily conceive variations and modifications of the resistor in other forms.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. In view of the foregoing, the spirit of the present invention should cover all such and other modifications and variations, which should be interpreted to fall within the scope of the following claims and their equivalents.

What is claimed is:

1. A circuit for electric over stress immunity, comprising:
a resistor receiving an external voltage;
a zener diode having a cathode electrically connected with the resistor; and
a functional circuit to be protected, which is electrically connected with both sides of the zener diode;
wherein the resistor, the zener diode and the functional circuit are integrated in an integrated circuit.

2. The circuit of claim 1, wherein the functional circuit is a power management circuit.

3. The circuit of claim 1, wherein a breakdown voltage of the zener diode is lower than a breakdown voltage of the functional circuit.

4. The circuit of claim 1, wherein the resistor has a resistance Rin which meets the relationship below:
(Vin−V_{ZBD})/I_{ZBD}_{_{—}}_{max<}Rin<(Vin−V_{MIN})/I_{OP}
wherein, V_{MIN} is a minimum operation voltage of the functional circuit; I_{OP} is an operation current of the functional circuit; V_{ZBD} is a breakdown voltage of the zener diode; and I_{ZBD}_{_{—}}ₘₐₓ is a maximum breakdown current of the zener diode.

5. The circuit of claim 1, wherein the resistor is made of one selected from an active device, a passive device, and a combination of the above.

6. The circuit of claim 1, wherein the resistor is one selected from a polysilicon line, an NMOS transistor, a PMOS transistor, a PNP BJT (Bipolar Junction Transistor), an NPN BJT, and two or more of the above devices connected in series or in parallel.
